(19) United States
(12) Patent Application Publication
(10) Pub. No.: US 2010/0247822 A1
(43) Pub. Date: Sep. 30, 2010

(54) VARIABLE DEPTH LASER SCORED EASY-OPEN POUCH FOR MICROWAVE STEAM VENTING

(76) Inventors: Evan Michael Ziolkowski, Menasha, WI (US); Scott Douglas Howells, Oshkosh, WI (US); Gregory William Kokke, Madison, WI (US); Brian Douglas, Neenah, WI (US)

Correspondence Address: BANNER & WITCOFF, LTD., TEN SOUTH WACKER DRIVE, SUITE 3000, CHICAGO, IL, 60606, US

(21) Appl. No.: 12/698,740

(22) Filed: Feb. 2, 2010

Related U.S. Application Data
(60) Provisional application No. 61/149,573, filed on Feb. 3, 2009.

(51) Int. Cl. B32B 1/04

(52) U.S. Cl. 428/35.2

(57) ABSTRACT

A multilayer film includes at least an abuse layer that is laser scored, and a sealant layer that has discrete weakened portions, due to the laser scoring. The multilayer film may have a tensile strength of between about 0.40 and 2.5 pounds per 10 millimeters at the location of the one or more weakened portions. In certain aspects, the tensile strength of the multilayer film is between about 7 and 14 pounds per inch at the location of the laser scoring on the abuse layer. Also, a package is provided that is formed from one or more multilayer films having a scored abuse layer and a sealant layer with weakened portions that allow steam and/or pressure to be vented from the package during heating. Optionally, the abuse layer includes a shallow scoring portion to provide an easy-open feature. For instance, the package may be used to cook frozen foods contained in the package, such as in a microwave oven.

### FIELD OF THE INVENTION

The invention relates to multilayer structures for packaging products to be cooked within the package. In particular, the multilayer structures are laser scored at one or more locations and/or depths to provide the capabilities of both easy tearing and steam venting when the structures are formed into packages.

### BACKGROUND

Frozen foods, for example vegetables, or meals containing a mixture of types of ingredients, such as meat, pasta and vegetables, are often sold to consumers in flexible polymeric packages. The foods may be prepared in a microwave oven, and to minimize the use of dishes, the entire package may be placed in the microwave oven for cooking. However, the heating of the food contents to a sufficient cooking temperature results in the production of pressure and/or steam within the package. Prior packages required piercing of the polymeric material by the consumer to allow release of the pressure/steam. Some current packages have vents provided in the package, but typically the vents form complete holes through the package film.

The polymeric materials used to make packages for frozen foods must be strong enough to prevent tearing of the package film, such as from abrasion of the frozen pieces against the interior of the package during filling, handling and transport. Consequently, the packages generally have a large tensile strength or tear strength, which requires a substantial amount of force to pull open the package, or the use of an instrument, such as scissors.

Accordingly, there is a need for a polymer package for frozen foods that can release steam and pressure during cooking and that is easy to open to allow a consumer to dispense the cooked product from the package safely, easily and without loss of product.

### SUMMARY

Aspects of the invention are directed to a multilayer film comprising an abuse layer and a sealant layer comprising one or more weakened portions. The multilayer film comprises a tensile strength of between about 0.4 and 2.5 pounds per 10 millimeters in the locations where weakened portions have been formed in the sealant layer. In certain aspects, the tensile strength of the abuse layer is between about 7 and 14 pounds per inch. In an embodiment, the abuse layer comprises a scored portion, which may have a depth that cuts partially or completely through the abuse layer to provide an easy-open feature.

In an alternate embodiment, a package is provided that is formed from one or more multilayer films comprising an abuse layer and a sealant layer comprising weakened portions that allow steam and/or pressure to be vented from the package during heating. The package may be formed from the multilayer film being sealed to itself or by the multilayer film being sealed to another film.

In a further embodiment, a multilayer film is provided comprising an abuse layer and a sealant layer comprising one or more weakened portions. The multilayer film comprises a tensile strength of between about 0.7 and 1.3 pounds per 10 millimeters in the locations where weakened portions have been formed in the sealant layer. Optionally, the sealant layer comprises between three and seven weakened portions.

### BRIEF DESCRIPTION OF THE DRAWINGS

FIG. 1 illustrates a package according to an embodiment, having a shallow score line and individual deep scored vents.

FIG. 2 illustrates a film according to an embodiment, having a single deep scored portion per section of film.

FIG. 3 illustrates a package according to an embodiment, having a single deep scored portion.

FIG. 4 illustrates a package according to an embodiment, having staggered individual deep scored portions.

FIG. 5 illustrates a package according to an embodiment, having linear individual deep scored portions.

FIG. 6 illustrates a cross-section of a multilayer polymeric film comprising a shallow score that cuts partially through the abuse layer.

FIG. 7 illustrates a cross-section of a multilayer polymeric film comprising a deep score that cuts completely through the abuse layer and adhesive layer and weakens the sealant layer.

### DETAILED DESCRIPTION OF EMBODIMENTS OF THE INVENTION

It was discovered that the use of scoring on a multilayer film could provide the dual functions of easy tearing and steam/pressure venting. Typically, the scoring is provided by a laser, such as an infrared laser. A multilayer film may be transported past a laser, for example, at a selected line speed, and the laser will cut a desired scoring pattern into the layers of the film. For instance, the laser may be programmed to alternate between lasing at a low amount of power for a period of time to form a shallow score that allows easy tearing of the film and lasing at a higher amount of power for a period of time to form a deeper score that allows venting of pressure through the film. In certain embodiments, more than one laser may be employed to form a plurality of scores in the film. Each of the lasers may form scored portions having the same or different depths, and in certain embodiments, the resulting scoring from multiple laser beams may be additive. Alternatively, any suitable instrument other than a laser may be employed to score the film.

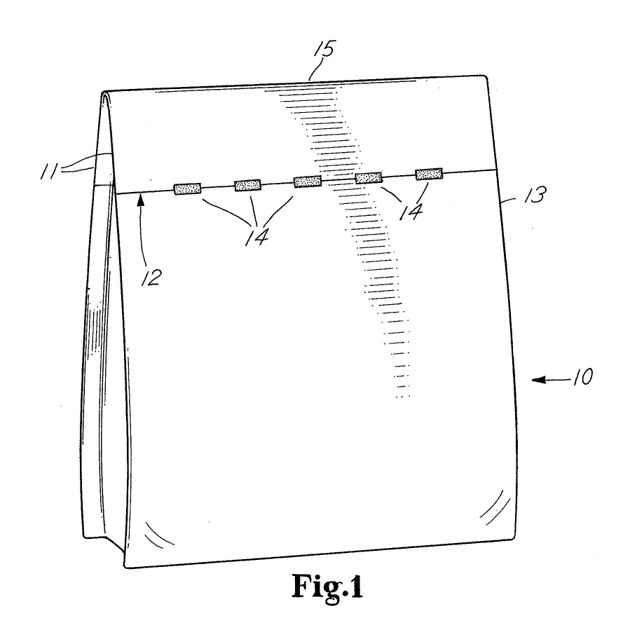

Referring to FIG. 1, an illustration is provided of a package 10 made from a multilayer film and scored according to an embodiment of the invention. In particular, the package 10 comprises a shallow depth score line 12 that crosses the full width of the package and that includes portions having deeper scoring to allow venting from inside the package. In this embodiment, a plurality of individual deep score portions 14 are located along the score line and set in away from the side edges 11 and 13 of the package 10. Any desired number of deep score portions may be provided on the package. The scoring is shown in FIG. 1 to be positioned on the upright package 10 at a distance from the top edge 15 of the package. In a further embodiment, the shallow depth scoring may not cross the full width of the multilayer film, but instead comprise discrete portions of shallow scoring located across the width of the film as well as portions that have not been scored at all. Such a package may be configured to align the scoring portions such that the shallow scoring portions across the front film are offset from the shallow scoring portions across the back film, for example. In alternate embodiments, the scoring may be formed at another location of a package, such as along one or more longitudinal edges, in the center of one or more sides, or along the bottom side of the package. Any suitable location for the vent is contemplated, based on the configuration of the package.

In another aspect of the invention, the laser may be programmed to score the multilayer film at more than two depths. For example, a lasing pattern having a shallow depth score near the edges of the multilayer film may be provided to minimize inadvertent tearing of the film during handling. Medium depth scoring may then be provided at a certain distance away from the edges of the film, alternating with areas of deep scoring to provide the venting functionality. In yet a further embodiment of the invention, the laser may be programmed to essentially continuously change power during lasing, such as to form a score that has a gradual variation in depth. For instance, the depth of the score across the multilayer film may have an appearance similar to a sinusoidal wave. All variations of score depths and widths are contemplated such that they allow both easy tearing and steam/pressure venting while maintaining the integrity of a package made from the multilayer film during typical handling.

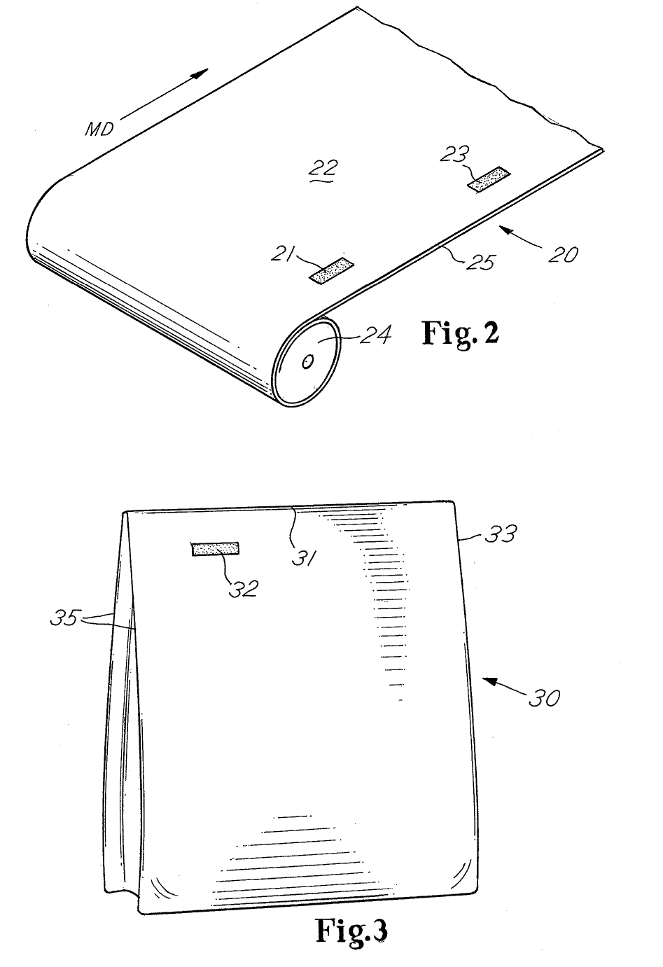

Referring to FIG. 2, in accordance with an aspect of the invention, an illustration is provided of a multilayer film positioned on a film roll 20, and scored according to an embodiment. In particular, the multilayer film 22 comprises a single portion having a deep scoring, to provide one vent 21 and 23 per section of multilayer film that will subsequently be cut to form separate pieces of multilayer film. In this embodiment, one individual deep score portion is located on each section of the multilayer film in the machine direction MD as the film is unwound from the film roll 24. In certain embodiments, a plurality of individual deep score portions may be provided on each section of the film, such as between three and seven score portions. The scored portion is shown in FIG. 2 to be positioned on the multilayer film at a predetermined distance from one edge 25 of the film.

Referring to FIG. 3, in accordance with another aspect of the invention, an illustration is provided of a package 30 made from a multilayer film. In particular, the package comprises a single portion having a deep scoring, to provide a vent 32 in the package. In this embodiment, one individual deep score portion is located on the package 30. In alternate embodiments, a plurality of individual deep score portions may be provided on the package. The scored portion 32 is shown in FIG. 3 to be positioned on the multilayer film of the package at a distance from the top edge 31 and offset to the left of the center between the longitudinal edges 33 and 35 of the upright package.

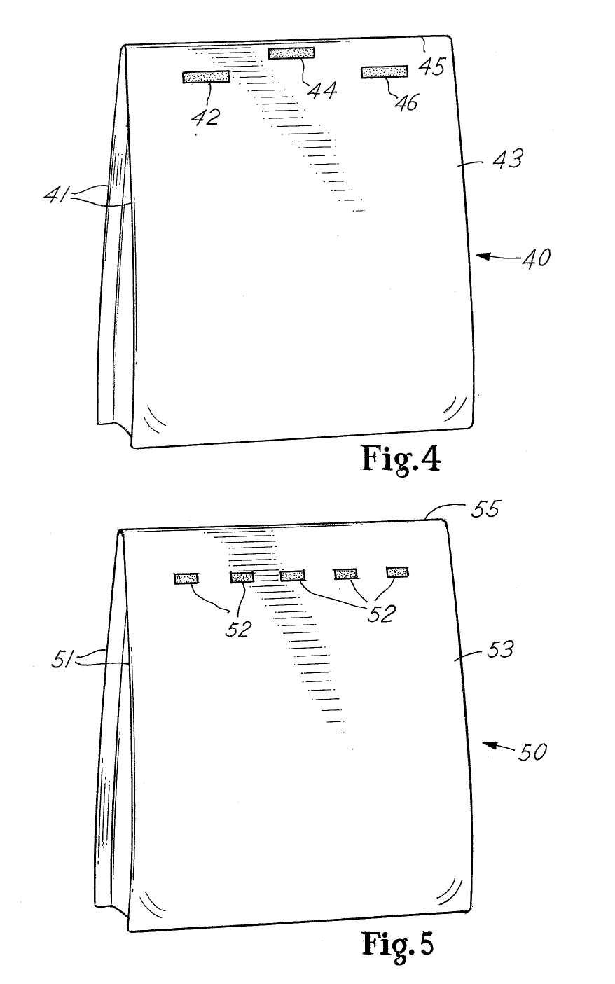

Referring to FIG. 4, in accordance with yet another aspect of the invention, an illustration is provided of a package 40 made from a multilayer film. In particular, the package 40 comprises a plurality of portions having a deep scoring, to provide vents 42, 44 and 46 in the package. In this embodiment, three individual deep score portions 42, 44 and 46 are located on the package 40. The scored portion is shown in FIG. 4 to be positioned on the multilayer film of the package in a staggered configuration, centered between the longitudinal edges 41 and 43 but at varying distances from the top edge 45 of the upright package.

Referring to FIG. 5, in accordance with a further aspect of the invention, an illustration is provided of a package 50 made from a multilayer film. In particular, the package 50 comprises a plurality of portions having a deep scoring, to provide vents 52 in the package 50. In this embodiment, five individual deep score portions 52 are located on the package 50. The scored portion is shown in FIG. 5 to be positioned on the multilayer film of the package in a linear configuration, centered between the longitudinal edges 51 and 53 and at a substantially constant distance from the top edge 55 of the upright package 50.

In certain embodiments, various shapes besides lines or dashes are formed by the laser beam scoring. For instance, vents may be provided by forming individual deep scored portions perpendicular to a longitudinal shallow score line, thereby forming a shape similar to stitches along a seam. Consequently, as will be appreciated by one of skill in the art, many different configurations of shallow and/or deep scored portions may be formed in multilayer films according to the invention to provide venting during microwave heating of packages comprising the multilayer films.

Any suitable laser and programming software may be employed to create the desired scoring pattern. Often, infrared lasers are used to score polymer packages, and the lasers may vary in power, such as between about 40 watts to about 400 watts. The percentage of total available power programmed at any specific point of the scoring process will depend on several variables, including but not limited to the line speed at which the multilayer film is run past the laser, the physical characteristics of the polymer materials contained in the film, the depths of the score portions and the width of the score portions.

In certain embodiments, more than one laser is employed to form a score pattern on a multilayer film. For example, on a film requiring five scored vents, one laser may be configured to score two vents and a second laser may be configured to score two other vents, while a third laser may be configured to score the final vent. Such an arrangement increases the speed with which a film may be scored. Any number of individual laser beams may be directed at the multilayer film to score the vents. Further, each of the individual lasers may be programmed to form scored vents having the same or different characteristics, including but not limited to depth, width, length, and relative location on the multilayer film.

The width of a laser beam may be selected depending on the type of film being scored. In an embodiment, a narrow laser beam is employed in order to more cleanly remove portions of the abuse layer from the multilayer film. In such embodiments, the spot size of the laser beam is between about 50 and 200 microns in diameter. In alternate embodiments, the spot size of the laser beam may be larger, such as between about 200 microns and about 1 millimeter in diameter. Current laser technology does not include laser beams having a spot size of below 50 microns, however, it is not believed that there would be any drawbacks to employing a laser having a spot size of less than 50 microns were one to become available. Typically, a score portion formed by a more narrow laser beam results in score portions that are less likely to be broken open by forces applied to the score portions during packaging, storage and transport of packages made from the multilayer film, as compared to a score portion formed by a wider laser beam.

The multilayer packaging films of the invention contain at least an abuse layer and a sealant layer. In certain embodiments, the packaging film further comprises an adhesive layer disposed between the abuse layer and the sealant layer. Generally, the film also comprises a printed layer to provide indicia that identify the products contained within a package made from the film, in addition to other information, graphics and the like. The printed layer may be located between the abuse layer and the adhesive layer by being applied to the abuse layer, for example, using methods such as flexographic printing or rotogravure printing. The multilayer film may be formed by any suitable method, for instance lamination.

In an aspect of the invention, the abuse layer comprises any suitable thermoplastic material, for example and without limitation, polyethylene terephthalate (PET), nylon, polypropylene, polyethylene (PE), polyvinylidene chloride (PVC), polystyrene or combinations thereof. In certain aspects, the abuse layer comprises, for example and without limitation, one or more of the above materials, polylactic acid (PLA), cellophane, paper, or combinations thereof. The abuse layer protects the multilayer film from being damaged by outside materials and provides an attractive appearance for the multilayer film. Any polymer material having sufficient toughness or strength to maintain the physical integrity of the multilayer film during packaging, storage, handling and transport may be used. Further, it is desirable to employ polymer materials in the abuse layer that are compatible with use in a microwave oven. Typically, the abuse layer comprises a thickness between about 0.35 and 1.25 mils, but the thickness may vary based on the physical characteristic requirements of the film and the product to be packaged using the film. In addition, the abuse layer may comprise more than one layer of material, for example two 0.48 mil layers of PET. When two or more thin layers make up the abuse layer, a printed layer may be provided in between two of the thin layers. In an embodiment, the abuse layer comprises a plurality of layers, such as a coextrusion, a multilayer film, etc. For instance, the abuse layer may comprise the following structure: PET/ink/adhesive/PET.

The multilayer film structure includes a sealant layer, which allows the film to be sealed to its own outer surface layer or to another multilayer film structure to form a package. The sealant layer may be a monolayer or a coextrusion, and may comprise any suitable sealant layer, such as a polyolefin. Further, it is desirable to employ polymer materials in the sealant layer that are compatible with use in a microwave oven. In certain embodiments, the package may be a bag or a pouch, such as for containing frozen products. The sealant layer may have a thickness between about 1.5 and 4.0 mils, such as about 2.0 mils, but the thickness may vary based on the physical characteristic requirements of the film and the product to be packaged using the film.

In an embodiment, the sealant layer is heat sealable. The term “heat sealable,” as used herein, means sealable or bondable by heat however obtained, for example, by induction or magnetic, ultrasonic, radio frequency, light or other energy sources which cause the materials to bond, fuse or otherwise seal. Such heat sealable materials usually are thermoplastic film forming polymers, are well-known in the art, and include without limitation, LLDPE, including all linear polyethylenes with a density of up to about 0.95 g/cc, LDPE, polypropylene, polypropylene-based plastomers, homopolymers or random copolymers, medium density polyethylene (MDPE), high density polyethylene (HDPE), ultra low density polyethylene, very low density polyethylene, olefins catalyzed by a single site catalyst such as metallocene, or a blend of any of these polymers.

The sealant layer must comprise at least about 50% by weight of materials that will melt and/or weaken upon exposure to a laser, but that will not vaporize. This is important because if the entire sealant layer was to vaporize, the deep scoring portions would in fact cut completely through the multilayer film. It is desirable to instead have an intact lamination over the entire film to protect the products contained within a package made from the film from damage or contamination. The inclusion of materials that will melt or weaken as a result of laser scoring allows a package made from the film to successfully vent pressure and/or steam out through the weakened portions during heating. Steam or pressure will cause the weakened portions to expand sufficiently to allow escape through the sealant layer polymer material, and/or create small tears in the sealant layer through which the steam and pressure may evacuate.

Various layers of the multilayer film structure may be adhered together with tie, or adhesive, layers. In an embodiment, a tie or adhesive layer may be a coextrusion of low density polyethylene (LDPE) and ethylene acrylic acid copolymer (EAA) or an anhydride modified polyethylene. In certain embodiments, the tie or adhesive layer comprises maleic anhydride modified polyethylene copolymer, such as ethylene vinyl acetate (EVA)-based or linear low density polyethylene (LLDPE)-based adhesive. The tie or adhesive layer may alternatively comprise any of the various other polymeric adhesives commonly used in the art of making multilayer films.

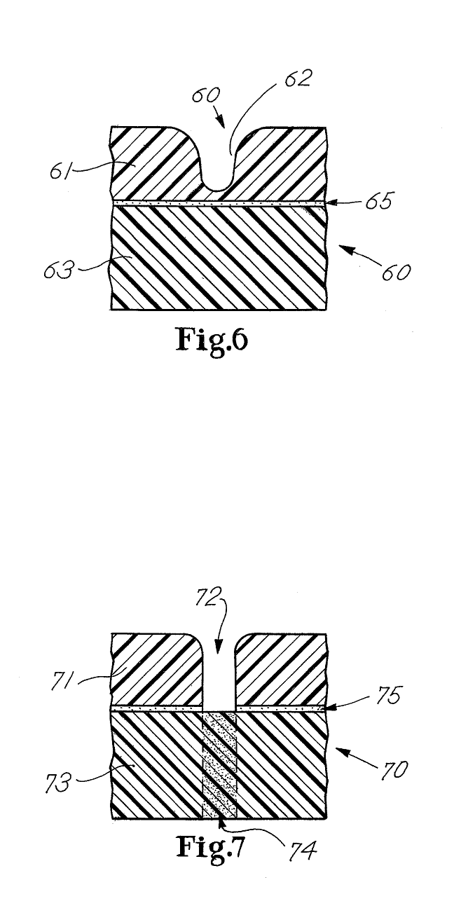

Referring to FIG. 6, in accordance with one aspect of the invention, a piece of a cross-section of a multilayer film 60 is illustrated showing a shallow score 62, which provides the easy-tear functionality. The multilayer film 60 includes an abuse layer 61 comprising PET, a sealant layer 63 comprising a polyethylene coextrusion, and an adhesive layer 65 disposed between the abuse and sealant layers. In this embodiment, the score cuts partially through the thickness of the abuse layer 61, but not completely. Alternatively, the shallow score may cut all of the way through the abuse layer, and optionally also into or through the adhesive layer. To provide an effective easy-tear capability, the multilayer film may have a tensile strength of between about 7 and 14 pounds per inch at the location of the scoring, such as about 10 pounds per inch. In contrast, multilayer films according to certain aspects, which have not been subjected to any laser scoring, may exhibit a tensile strength of between about 20 and 25 pounds per inch, or more. Accordingly, the material used to form the abuse layer, the thickness of the abuse layer and the score depth of the scoring portion may each be selected to, in combination, provide the desired tensile strength.

Referring to FIG. 7, in accordance with one aspect of the invention, a piece of a cross-section of a multilayer film 70 is illustrated showing a deep score 72, which provides the venting functionality. The multilayer film 70 includes an abuse layer 71 comprising PET, a sealant layer 73 comprising a polyethylene coextrusion, and an adhesive layer 75 disposed between the abuse and sealant layers. In this embodiment, the score cuts completely through the abuse layer 71 and through the adhesive layer 75, and has resulted in the weakening of the sealant layer 73. Without wishing to be bound by theory, it is believed that the laser scoring may melt the sealant layer at least a portion of the way through the thickness of the layer, followed by re-solidification. The re-solidified portion 74 generally does not have as much tensile strength as a portion that was not melted and re-solidified.

To provide an effective venting capability, the multilayer film may have a tensile strength of between about 0.4 and about 2.5 pounds per 10 millimeters at the locations of the one or more weakened portions of the sealant layer, such as between about 0.6 and 1.75 pounds per 10 millimeters, or between about 0.7 and 1.3 pounds per 10 millimeters, or between about 0.8 and 1.1 pounds per 10 millimeters. These ranges of tensile strength allow the weakened portions to easily expand or tear to release steam and/or pressure when the multilayer film is formed into a package containing a food product and heated, such as in a microwave oven. The weakened portions may be discrete sections having desired widths, and may be positioned in any number or any location on the multilayer film. Preferably, the weakened portions are positioned at a distance from where a consumer is likely to handle a package made from the film such that when touching a hot package, the possibility of contact with steam is minimized.

In an alternate embodiment, the multilayer film may be subjected to laser beams directed at the sealant layer, to weaken the sealant layer without also scoring through the abuse layer. Such a configuration may be selected when the abuse layer is capable of being expanded or torn to release steam and/or pressure during heating. For example, a multilayer film comprising a polyethylene abuse layer would be suitable for laser scoring at the sealant layer.

In certain embodiments, the weakened portions have a width of 5 millimeters or greater. Generally, weakened portions narrower than about 5 millimeters have a tendency to tear abruptly when under pressure and create a loud noise when the pressure is released. Moreover, weakened portions narrower than 5 millimeters occasionally result in undesirable failure of the seal of a package made from the multilayer film when it is subjected to internal pressure during heating. However, in embodiments in which the production of a noise is desired, weakened portions comprising a width of less than 5 millimeters may be employed, whereas when a quieter venting is preferred, the weakened portions comprise a width of at least 5 millimeters. Consequently, the materials used to form the abuse and sealant layers, the thickness of the abuse and sealant layers, the score depth of the scoring portions and the width of the weakened portions may each be selected to, in combination, provide the desired tensile strength.

Multilayer film structures of embodiments of the invention may be made via cast coextrusion, extrusion coating and/or extrusion lamination, adhesive lamination, blown-film coextrusion or water-quenched coextrusion or any other film-making method generally known to those having ordinary skill in the art. As noted above, the abuse layer may be laminated to the other layers, which may be prepared by numerous methods known in the art. Embodiments of the multilayer film package structure may have a total film thickness of less than about 5.0 mils.

### EXAMPLES

The following examples are illustrative of embodiments of the present invention, as described above, and are not meant to limit the invention in any way.

### Example 1

A six-layer film was prepared comprising the following layers in order from outer layer to sealant layer: PET/ink/adhesive/PET/adhesive/LLDPE. The PET layers that together made up the abuse layer each had a thickness of 0.48 mils, and the LLDPE sealant layer had a thickness of 2.0 mils. The multilayer film was laser scored at a line speed of 225 feet per minute using a 100-watt infrared laser, with both shallow portions and deep portions. The shallow portions were scored using 10% of the total laser power to a depth of about 0.78 mils, which is about 85% of the combined abuse layer thickness of 0.96 mils. The deep portions were scored using 100% of the total laser power, and five deep portions, each having a width of 10 millimeters, were made across the film.

Three replicates of individually prepared rolls of the multilayer film were each tested according to ASTM method D-882, employing a 10 mm sample, to determine the tensile strength of the film along the score line at the locations of the deep portions. The results of the tensile testing are provided in Table 1 below. The multilayer film samples had a tensile strength ranging from 1.031 pounds per 10 millimeters to 1.690 pounds per 10 millimeters.

TABLE 1
Tensile strength for samples of Example 1

| Roll No. | End (10 mm slit) | Roll No. | End (10 mm slit) | Roll No. | End (10 mm slit) |
|---|---|---|---|---|---|
| 7-2 | 1.469 | 6-3 | 1.242 | 3-1 | 1.648 |
| | 1.498 | | 1.110 | | 1.562 |
| | 1.462 | | 1.326 | | 1.267 |
| 7-1 | 1.317 | 1-1 | 1.464 | 4-2 | 1.430 |
| | 1.484 | | 1.408 | | 1.365 |
| | 1.690 | | 1.513 | | 1.532 |
| 7-3 | 1.451 | 1-3 | 1.050 | 2-2 | 1.269 |
| | 1.573 | | 1.270 | | 1.031 |
| | 1.560 | | 1.270 | | 1.145 |
| 5-2 | 1.407 | 1-2 | 1.394 | 1-1 | 1.286 |
| | 1.442 | | 1.393 | | 1.391 |
| | 1.350 | | 1.376 | | 1.353 |
| 4-3 | 1.423 | 2-2 | 1.183 | 3-3 | 1.592 |
| | 1.541 | | 1.232 | | 1.621 |
| | 1.610 | | 1.242 | | 1.488 |
| 6-1 | 1.400 | 2-1 | 1.387 | 3-2 | 1.304 |
| | 1.389 | | 1.292 | | 1.533 |
| | 1.451 | | 1.328 | | 1.357 |
| 5-3 | 1.537 | 2-3 | 1.333 | 2-3 | 1.618 |
| | 1.630 | | 1.385 | | 1.391 |
| | 1.335 | | 1.451 | | 1.162 |
| 4-1 | 1.672 | 3-1 | 1.328 | 1-3 | 1.328 |
| | 1.203 | | 1.422 | | 1.527 |
| | 1.660 | | 1.536 | | 1.565 |
| 4-2 | 1.550 | 3-3 | 1.134 | 1-2 | 1.393 |
| | 1.558 | | 1.513 | | 1.369 |
| | 1.270 | | 1.471 | | 1.559 |
| 5-1 | 1.580 | 3-2 | 1.276 | 2-1 | 1.199 |
| | 1.460 | | 1.353 | | 1.313 |
| | 1.400 | | 1.287 | | 1.307 |

| | |
|---|---|
| 6-2 | 1.147 |
| | 1.248 |
| | 1.622 |

### Example 2

A four-layer film was prepared comprising the following layers in order from outer layer to sealant layer: PET/ink/adhesive/PP. The PET layer had a thickness of 0.92 mils, and the polypropylene (PP) sealant layer had a thickness of 3.0 mils. The multilayer film was laser scored at a line speed of 150 feet per minute using three 40-watt infrared lasers, with individual deep portions. The deep portions were scored using 100% of the total laser power, and five deep portions, each having a width of 10 millimeters, were made across the film. The film was scored to have a tensile strength of 1.1 (±0.15) pounds per 10 millimeters at the locations of the deep portions. The three lasers were positioned linearly in the machine direction, and one laser formed the first two adjacent score portions, the second laser formed the next two adjacent score portions, and the third laser formed the last adjacent score portion. The beams of the lasers were allowed to move a short distance, such as up to about three inches (˜72 millimeters) in order to form a substantially straight score portion while the multilayer film was continuously moving at the line speed.

Five replicates of individually prepared rolls of the multilayer film were each tested according to ASTM method D-882, employing a 10 mm wide sample, to determine the tensile strength of the film at the locations of the deep portions. The results of the tensile testing are provided in Table 2 below. The multilayer film samples had a tensile strength ranging from 1.02 pounds per 10 millimeters to 1.35 pounds per 10 millimeters.

TABLE 2
Tensile strength for samples of Example 2.

| | Tensile Strength |
|---|---|
| Sample | (lb/cm) |
| 1 | 1.19 |
| 2 | 1.03 |
| 3 | 1.35 |
| 4 | 1.02 |
| 5 | 1.26 |
| Average | 1.17 |
| Standard Deviation | 0.14 |

### Example 3

A four-layer film was prepared comprising the following layers in order from outer layer to sealant layer: PET/ink/adhesive/PP. The PET layer had a thickness of 0.92 mils, and the polypropylene (PP) sealant layer had a thickness of 3.0 mils. The multilayer film was laser scored at a line speed of 150 feet per minute using three 40-watt infrared lasers, with individual deep portions. The deep portions were scored using 100% of the total laser power, and five deep portions, each having a width of 10 millimeters, were made across the film. The film was scored to have a tensile strength of 0.90 (±0.15) pounds per 10 millimeters at the locations of the deep portions. The three lasers were positioned linearly in the machine direction, and one laser formed the first two adjacent score portions, the second laser formed the next two adjacent score portions, and the third laser formed the last adjacent score portion. The beams of the lasers were allowed to move a short distance, such as up to about three inches (˜72 millimeters) in order to form a substantially straight score portion while the multilayer film was continuously moving at the line speed.

Five replicates of individually prepared rolls of the multilayer film were each tested according to ASTM method D-882, employing a 10 mm wide sample, to determine the tensile strength of the film at the locations of the deep portions. The results of the tensile testing are provided in Table 3 below. The multilayer film samples had a tensile strength ranging from 0.84 pounds per 10 millimeters to 0.92 pounds per 10 millimeters.

TABLE 3
Tensile strength for samples of Example 3.

| | Tensile Strength |
|---|---|
| Sample | (lb/cm) |
| 1 | 0.86 |
| 2 | 0.92 |
| 3 | 0.87 |
| 4 | 0.84 |
| 5 | 0.87 |
| Average | 0.872 |
| Standard Deviation | 0.03 |

While the invention has been described with respect to specific examples including presently preferred modes of carrying out the invention, those skilled in the art will appreciate that there are numerous variations and permutations of the above described structures that fall within the spirit and scope of the invention. It should be understood that the invention is not limited in its application to the details of construction and arrangements of the components set forth herein. Variations and modifications of the foregoing are within the scope of the present invention. It is also being understood that the invention disclosed and defined herein extends to all alternative combinations of two or more of the individual features mentioned or evident from the text. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art. It is therefore contemplated that such modifications can be made without departing from the spirit or scope of the present invention as defined in the appended claims.

1. A multilayer film comprising:
an abuse layer having a thickness; and
a sealant layer comprising one or more weakened portions,
wherein the multilayer film exhibits a tensile strength of between 0.4 and 2.5 pounds per 10 millimeters at the location of the one or more weakened portions.

2. The multilayer film of claim 1, wherein the abuse layer comprises a first score portion comprising a depth.

3. The multilayer film of claim 2, wherein the depth of the first score portion is at least equal to the thickness of the abuse layer.

4. The multilayer film of claim 2, wherein the depth of the first score portion is less than the thickness of the abuse layer.

5. The multilayer film of claim 4, wherein the multilayer film exhibits a tensile strength of between 7 and 14 pounds per inch at the location of the first score portion.

6. The multilayer film of claim 1, wherein the sealant layer comprises a material that melts or weakens upon exposure to a laser beam but does not vaporize.

7. The multilayer film of claim 6, wherein the sealant layer comprises a polyolefin material.

8. The multilayer film of claim 1, wherein the abuse layer comprises polyethylene terephthalate, nylon, biaxially oriented nylon, polyethylene, polypropylene, polyvinylidene chloride, and combinations thereof.

9. The multilayer film of claim 1, wherein the abuse layer comprises polylactic acid, paper, cellophane, and combinations thereof.

10. The multilayer film of claim 1, wherein the multilayer film exhibits a tensile strength of between 0.7 and 1.3 pounds per 10 millimeters at the location of the one or more weakened portions.

11. The multilayer film of claim 1, wherein the one or more weakened portions each has a width of 5 millimeters or greater.

12. The multilayer film of claim 2, wherein the depth of the first score portion varies along the score portion.

13. The multilayer film of claim 1, further comprising an adhesive layer disposed between the abuse layer and the sealant layer.

14. The multilayer film of claim 10, wherein the multilayer film exhibits a tensile strength of between 0.8 and 1.1 pounds per 10 millimeters at the location of the one or more weakened portions.

15. A package comprising a first multilayer film comprising:
an abuse layer having a thickness; and
a sealant layer comprising one or more weakened portions,
wherein the multilayer film exhibits a tensile strength of between 0.4 and 2.5 pounds per 10 millimeters at the location of the one or more weakened portions.

16. The package of claim 15, further comprising a second multilayer film sealed to the first multilayer film.

17. The package of claim 15, wherein the abuse layer comprises a first score portion.

18. The package of claim 15, wherein the package is formed from the first multilayer film being sealed to itself.

19. The package of claim 17, wherein the package comprises a first width, the first score portion has a second width, and the first width is greater than the second width.

20. The package of claim 15, wherein the one or more weakened portions each has a width of 5 millimeters or greater.

20. The package of claim 15, wherein the multilayer film exhibits a tensile strength of between 0.7 and 1.3 pounds per 10 millimeters at the location of the one or more weakened portions.

21. A multilayer film comprising:
an abuse layer; and
a sealant layer comprising one or more weakened portions,
wherein the multilayer film exhibits a tensile strength of between 0.7 and 1.3 pounds per 10 millimeters at the location of the one or more weakened portions.

22. The multilayer film of claim 21, wherein the sealant layer comprises between three and seven weakened portions.
